(19) United States
(12) Patent Application Publication
(10) Pub. No.: US 2024/0423257 A2
(43) Pub. Date: Dec. 26, 2024

(54) CRUMBLE PIECES COMPRISING PLANT-SOURCED LIPID AND INULIN

(71) Applicant: CARGILL, INCORPORATED, WAYZATA, MN (US)

(72) Inventors: Timm Adams, Eden Prairie, MN (US); Serpil Metin, Plymouth, MN (US); Joseph Purl, Wichita, KS (US); Conor Sullivan, Hopkins, MN (US)

(73) Assignee: CARGILL, INCORPORATED, WAYZATA, MN (US)

(21) Appl. No.: 18/249,673

(22) PCT Filed: Oct. 19, 2021
(86) PCT No.: PCT/US21/55633

§ 371 Date: Apr. 19, 2023

Related U.S. Application Data
(60) Provisional application No. 63/093,751, filed on Oct. 19, 2020.

(51) Int. Cl. A23P 20/20

(52) U.S. Cl. CPC A23P 20/20

(57) ABSTRACT

Plant-sourced lipid and inulin crumble pieces are prepared by providing an inulin gel composition; providing a plant-sourced lipid composition in liquid form; mixing the plant-sourced lipid composition in liquid form with the inulin gel composition to provide a liquid lipid/inulin composition comprising from about 5% to about 60% inulin gel; and reducing the temperature of the liquid lipid/inulin composition with continued mixing to a temperature such that the phase of the lipid/inulin composition changes from liquid to sufficiently solid that the lipid/inulin composition fractures into discrete plant-sourced lipid and inulin crumble pieces. In an aspect, the discrete plant-sourced lipid and inulin crumble pieces may be frozen.

### CROSS-REFERENCE TO RELATED APPLICATIONS

This application is a national phase application of PCT Application No. PCT/US2021/055633, filed Oct. 19, 2021, which claims the benefit of U.S. Provisional Patent Application No. 63/093,751, filed Oct. 19, 2020, each of which is hereby incorporated by reference in its entirety.

### FIELD

The present invention relates to plant-sourced lipid and inulin crumble pieces.

### BACKGROUND

Consumers increasingly desire protein choices that are alternatives to animal meat protein for a variety of reasons. At the same time, many consumers enjoy the flavors and textures that are uniquely provide by meats obtained from animals. For this reason, a number of companies have striven to provide plant-based meat substitutes that replicate the experience of cooking and eating meat.

Examples of plant-based meat substitute products include the Impossible Burger from Impossible Foods, The Beyond Burger from Beyond Meat, and Ultimate Beefless Burger from Gardein. These and other products are discussed, for example, at https://www.healthline.com/nutrition/vegan-meat-substitutes #section4, which states that the Beyond Burger is made from pea protein, canola oil, coconut oil, potato starch and other ingredients.

U.S. Pat. No. 9,700,067 to Fraser et.al and assigned to Impossible Foods describes a ground beef-like food product comprising a heme-containing protein, plant proteins, and additional compounds, wherein cooking the ground beef-like food product results in the production of at least two volatile compounds which have a beef-associated aroma. Particular flavor precursors or compositions are described, including, for example, yeast extract, vegetable oil, corn oil, soybean oil, palm fruit oil, palm kernel oil, safflower oil, flaxseed oil, rice bran oil, cottonseed oil, olive oil, canola oil, sunflower oil, coconut oil, mango oil, or an algal oil. See, e.g., column 2, lines 55-59. Formulations of replica burgers comprising coconut oil are described in the Examples.

Likewise, extruded meat substitute compositions are described in WO 2017/046659 that comprise one or more sources of plant protein, one or more sources of lipid, one or more sources of carbohydrate, and water, wherein the one or more sources of carbohydrate may in some embodiments comprise fruit, fruit powder or chia seed extract, or any combination of any two or more thereof. In this composition, the sources of lipid may comprise a plant fat or oil, such as coconut, corn, cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

Edible oils have been used as vehicles to add supplements, nutraceuticals, or nutritive ingredients to ground meat or processed meat or game meat through a fat emulsion component. See, e.g., WO 2012/094397 to Ervin et al.

Particulate fat replacement systems are described in U.S. Pat. No. 5,658,609 to Abboud, et al. The fat replacement system is disclosed to include in combination (a) an emulsifier powder which includes a carrier, propylene glycol monoester, mono- and di-glycerides, a polyoxyethylene derivative of polyol esters of fatty acids and diacetyl tartaric acid ester of monoglycerides and (b) an unhydrated mixture of a vegetable fiber, starch and a gum.

Combinations of a substantially linear polymeric polysaccharides (such as inulin) and an insoluble material to obtain a particle gel composition have been described as fat replacement compositions in U.S. Pat. No. 6,149,962.

### SUMMARY

It has been found that plant-sourced lipid composition comprising inulin provided in the form of discrete plant-sourced lipid and inulin crumble pieces can be advantageous components for partial or complete replacement of other fats in food products. In an aspect, it has been found that the discrete plant-sourced lipid and inulin crumble pieces exhibit physical properties for use as excellent replacements for fat chips in ordinary cooking and baking applications. The discrete plant-sourced lipid and inulin crumble pieces exhibit excellent crystallization temperatures and melting characteristics, so that they mimic characteristics of animal fats. Due to the composition and mixing techniques as described herein, the discrete plant-sourced lipid and inulin crumble pieces exhibit excellent moisture retention properties in use. These properties together afford excellent mouthfeel characteristics in the final products comprising the discrete plant-sourced lipid and inulin crumble pieces. Additionally, due to the composition and mixing techniques as described herein, the discrete plant-sourced lipid and inulin crumble pieces exhibit excellent visual characteristics, including color and overall appearance, so that they can be prepared in a manner to approximate the appearance of conventional fat chips or solid fat portions.

Moreover, because the discrete plant-sourced lipid and inulin crumble pieces comprise a substantial amount of inulin, the amount of fats, and in particular saturated fats, may be substantially lower than would be conventionally present in meat products having a like protein/fat composition, with excellent organoleptic performance. This reduction in fat content is of benefit not only when the final food product would ordinarily contain animal-sourced fats, but also when the final food product would ordinarily contain plant-sourced fats. Additionally, because the present discrete plant-sourced lipid and inulin crumble pieces comprises inulin and may additionally comprise selected advantageous fats, the amount of saturated fat and/or the calorie content of the final food product may be reduced as compared to final food products comprising fat compositions that do not comprise inulin. Moreover, the incorporation of inulin provide an additional fiber source, which is a nutritional benefit not afforded by conventional fat.

Because the present discrete plant-sourced lipid and inulin crumble pieces use plant-sourced fats, the present crumbles in particular can be advantageously used as replacements for animal-sourced fats.

It has further been found that meat substitute products often fall short of the desired organoleptic experience because they lack one or more of the visual and textural characteristics of the animal meat it is intended to mimic. The interplay between the protein components and the fat components of the animal meat is particularly difficult to present when using non-meat sourced ingredients. It has been discovered that an effective animal fat mimetic (e.g. a beef fat mimetic) can be prepared by careful selection of the plant based lipid source and the processing steps carried out to prepare the plant based lipid in a format suitable for combining with a protein source in a manner that provides a pleasing animal meat mimetic.

In an aspect, a plant-sourced lipid and inulin crumble pieces are prepared by a process comprising providing an inulin gel composition; providing a plant-sourced lipid composition in liquid form; mixing the plant-sourced lipid composition in liquid form with the inulin gel composition to provide a liquid lipid/inulin composition comprising from about 5% to about 60% inulin; and reducing the temperature of the liquid lipid/inulin composition with continued mixing to a temperature such that the phase of the lipid/inulin composition changes from liquid to sufficiently solid that the lipid/inulin composition fractures into discrete plant-sourced lipid and inulin crumble pieces. In an aspect, the discrete plant-sourced lipid and inulin crumble pieces are then frozen.

In an aspect, an animal meat mimetic is prepared by mixing the discrete plant-sourced lipid and inulin crumble pieces with a composition comprising hydrated plant protein. In an aspect, the animal meat mimetic product is mixed with actual animal products, such as ground beef, ground turkey, ground chicken and the like to form a hybrid animal protein products.

It has been found that animal meat mimetic products and hybrid animal protein products comprising the discrete plant-sourced lipid and inulin crumble pieces exhibit excellent organoleptic benefits, such as sensory, visual, mouthfeel, color, flavor, and moisture release properties.

It additionally has been found that the discrete plant-sourced lipid and inulin crumble pieces exhibit excellent color contrast to the protein portion of final product, which provides excellent product appearance so that the lipid component is apparent to the consumer. Because of this color contrast, the final product has an appearance more closely approximating the appearance of a meat product, enhancing the consumer experience in interaction with the product.

The discrete plant-sourced lipid and inulin crumble pieces facilitate the ability to substantially reduce the amount of animal sourced components in consumer diets, which appeals to many consumers from the perspective of resource use, sustainability, reduced cost, and health benefits. In an aspect, the discrete plant-sourced lipid and inulin crumble pieces facilitate preparation of food products that may labeled as not containing animal sourced materials.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the embodiments serve to explain the principles of the invention. A brief description of the drawings is as follows:

FIG. 1 is a process flow diagram illustrating an aspect of the process as described herein.

FIG. 2 is a photograph of an aspect of a discrete plant-sourced lipid and inulin crumble pieces as described herein.

FIG. 3 is a photograph of a breakfast patty comprising an aspect of a discrete plant-sourced lipid and inulin crumble pieces as described herein.

FIG. 4 is a photograph of an aspect of a discrete plant-sourced lipid and inulin crumble pieces as described herein.

FIG. 5 is a photograph of vegan beef type patties comprising an aspect of a discrete plant-sourced lipid and inulin crumble pieces as described herein.

FIG. 6 is a perspective photograph of a cut vegan beef type patties comprising an aspect of a discrete plant-sourced lipid and inulin crumble pieces as described herein.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

For purposes of the present disclosure, a lipid composition is a composition that comprises triacyl glycerides of any melting point. Thus, the plant-sourced lipid composition may comprise triacyl glycerides that are liquid at room temperature, which are often called oils or solids at room temperature, which are often called fats.

For purposes of the present disclosure, a lipid composition or a lipid/inulin composition is in the liquid state at any given temperature when the plant-sourced lipid composition can be poured. In an aspect, the plant-sourced lipid composition in the liquid state may comprise suspended crystals or solid regions.

For purposes of the present disclosure, a lipid composition or a lipid/inulin composition is in the solid state when crumble pieces thereof are self supporting and do not change particle dimension (i.e., do not flow) over a time of 5 minutes at a temperature of 4.5° C. It has been found that dimensional stability of the crumble pieces at this temperature is advantageous for maintaining the integrity of the pieces under convenient temperatures for product production, and also for standard final product storage conditions. In an aspect, a lipid composition or a lipid/inulin composition is in the solid state when crumble pieces thereof are self supporting and do not change particle dimension (i.e., do not flow) over a time of 5 minutes at a temperature of 10° C. It has been found that dimensional stability of the crumble pieces at a temperature of 10° C. is advantageous for maintaining the integrity of the pieces under more challenging temperatures for product production, and also for final product storage conditions that may experience some fluctuation in temperature, for example, during transit.

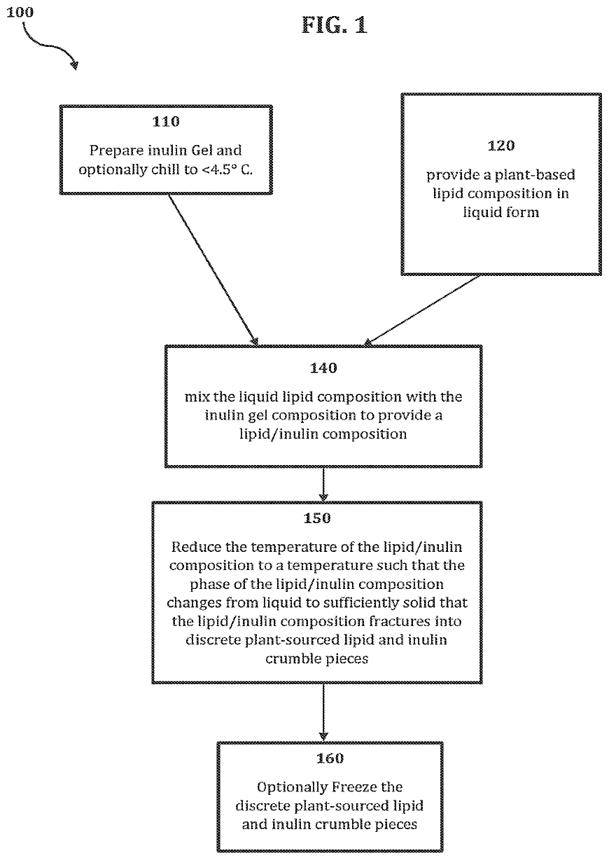

FIG. 1 shows an exemplary process 100 for preparing plant-sourced lipid and inulin crumble pieces according to an aspect of the present disclosure. As shown, process 100 includes a step 110 wherein an inulin gel is prepared and optionally chilled.

In an aspect, the inulin used to prepare the inulin gel is a long-chain inulin, such as LXL inulin from Cosucra. In an aspect, the inulin is a so-called “instant” inulin, such as Fibruline® Instant inulin from Cosucra, that is formulated for easy dispersion. The inulin to be used can be a commercial form of inulin. In an aspect, the inulin can be sourced from any appropriate inulin source, such as chicory, dahlias, Jerusalem artichokes, and the like. In an aspect, the inulin has a chain length of 3 to 60 sugar units. In an aspect, the inulin has an average chain length of 8 to 30 fructose units (DP=8-30). In an aspect, the inulin has an average chain length of 8 to 20 fructose units (DP=8-20). In an aspect, short chains (5 or less fructose units) make up less than 25% (by weight) of the total inulin. The chain length can be that of the natural product, or can advantageously have been modified by hydrolysis, enzymatic chain lengthening or separation techniques such as crystallization or chromatography. Additional information regarding inulin materials that may be used is described in WO 00/56178, the disclosure of which is incorporated by reference.

The inulin gel is provided by mixing inulin with water under shear to prepare a slurry. In an aspect, the slurry is allowed to rest for a time sufficient to form a gel. In an aspect, inulin is mixed with water at an inulin/water weight ratio of from about 5 to about 35. In an aspect, inulin is mixed with water at an inulin/water weight ratio of from about 10 to about 30 wt %. In an aspect, inulin is mixed with water at an inulin/water weight ratio of from about 15 to about 25 wt %. In an aspect, the inulin is a commercially available inulin, and the gel is prepared according to manufacturer's specifications.

In an aspect, after preparation of the inulin gel, the inulin gel is cooled to a temperature of from about 0 to about 4.5° C. to provide a chilled inulin gel composition. In an aspect, the chilled inulin gel composition is held at a temperature of from about 0 to about 4.5° C. for a time of about 5 to 28 hours prior to mixing with the liquid lipid composition. It has been found that holding the chilled inulin gel composition for a time period prior to mixing with the liquid lipid composition is beneficial to the preparing a well mixed and stable product of discrete plant-sourced lipid and inulin crumble pieces. While not being bound by theory, it is believed that holding the chilled inulin gel composition for this time period enhances stability of the gel during the potentially disruptive mixing step. In an aspect, the chilled inulin gel composition is held at a temperature of from about 0 to about 4.5° C. for a time of about 5 to 12 hours prior to mixing with the liquid lipid composition. It has been found that this time period provides the above noted benefits while at the same time facilitating completion of at least a substantial portion of the present process within a single work shift, or within adjacent work shifts. In an aspect, the chilled inulin gel composition is held at a temperature of from about 0 to about 4.5° C. for a time of about 12 to 18 hours prior to mixing with the liquid lipid composition. It has been found that this time period provides the above noted benefits while at the same time facilitating the convenient scheduling of carrying out key tasks of the present process on consecutive work days.

In a separate step 120, a plant-sourced lipid composition is provided in liquid form. In an aspect, the plant-sourced lipid composition is a liquid at the ambient temperature of the mixing equipment used. In an aspect, the plant-sourced lipid composition is a liquid at the room temperature (i.e. 23° C.). In an aspect, the plant-sourced lipid composition is a solid (i.e. does not flow) at room temperature, and is heated to liquid form. In an aspect, the plant-sourced lipid composition plant-sourced lipid composition and is heated to a temperature that is above the melting point of the plant-sourced lipid composition to melt the lipid, i.e. to provide a heated liquid lipid composition that can be poured out of a vessel. This heated liquid lipid composition is then ready for mixing with the inulin gel in step 130 as discussed below. In an aspect, the plant-sourced lipid composition is heated to a temperature that is above the melting point of the plant-sourced lipid composition to melt the lipid and then cooled to a temperature of about 38° C. or less. It has been found that if the plant-sourced lipid composition is added to the inulin gel at a temperature above about 38° C., the inulin gel may be adversely affected and it may be difficult to prepare the desired discrete plant-sourced lipid and inulin crumble pieces. It has further been found that a plant-sourced lipid composition that has a melting point above about 38° C. can be cooled to desired mixing temperature of about 38° C. or less under conditions such that the plant-sourced lipid composition is sufficiently liquid that it flows and mixes with the inulin to provide the desired lipid/inulin composition. In an aspect, the cooling takes place as a quick cooling process with immediate mixing to prevent solidification of the lipid composition before mixing.

In an aspect, the plant-sourced lipid composition to be used in the present process is a lipid composition having a melting point of from about 20° C. to about 60° C. In an aspect, the plant-sourced lipid composition to be used in the present process is a lipid composition having a melting point of from about 30° C. to about 60° C. In an aspect, the plant-sourced lipid composition to be used in the present process is a lipid composition having a melting point of from about 20° C. to about 40° C. In an aspect, the plant-sourced lipid composition to be used in the present process is a lipid composition having a melting point of from about 20° C. to about 36° C. In an aspect, the plant-sourced lipid composition to be used in the present process is a lipid composition having a melting point of from about 20° C. to about 30° C. In an aspect, the plant-sourced lipid composition comprises a lipid selected from the group consisting of palm oil (including palm olein and palm super olein), shea butter, cocoa butter, coconut oil, palm kernel, jojoba butter, murumuru butter, mango butter, and mixtures thereof and including fractions, interesterifications and hydrogenations thereof. In an aspect, the plant-sourced lipid composition comprises a lipid selected from the group consisting of palm oil, shea butter, cocoa butter, coconut oil, palm kernel, and mixtures thereof and including fractions, interesterifications and hydrogenations thereof. In an aspect, the plant-sourced lipid composition comprises a lipid selected from the group consisting of palm oil, cocoa butter, coconut oil, and mixtures thereof and including fractions, interesterifications and hydrogenations thereof. In an aspect, the plant-sourced lipid composition comprises at least 90% of palm oil. In an aspect, the plant-sourced lipid composition comprises at least 90% of shea butter. In an aspect, the plant-sourced lipid composition comprises at least 90% of cocoa butter. In an aspect, the plant-sourced lipid composition comprises at least 90% of coconut oil. In an aspect, the plant-sourced lipid composition comprises at least 90% of palm kernel. In an aspect, the plant-sourced lipid composition comprises at least 90% of jojoba butter. In an aspect, the plant-sourced lipid composition comprises at least 90% of murumuru butter. In an aspect, the plant-sourced lipid composition comprises at least 90% of mango butter. In an aspect, the plant-sourced lipid composition comprises at least 95% of palm oil. In an aspect, the plant-sourced lipid composition comprises at least 95% of shea butter. In an aspect, the plant-sourced lipid composition comprises at least 95% of cocoa butter. In an aspect, the plant-sourced lipid composition comprises at least 95% of coconut oil. In an aspect, the plant-sourced lipid composition comprises at least 95% of palm kernel. In an aspect, the plant-sourced lipid composition comprises at least 95% of jojoba butter. In an aspect, the plant-sourced lipid composition comprises at least 95% of murumuru butter. In an aspect, the plant-sourced lipid composition comprises at least 95% of mango butter.

In an aspect, the plant-sourced lipid composition may comprise an additional lipid that alone would not meet the above noted melting point requirement of from about 20° C. to about 60° C., but which is added in an amount such that the overall lipid composition has a melting point of from about 20° C. to about 60° C. In an aspect, the plant-sourced lipid composition may comprise an additional lipid that alone would not meet the above noted melting point requirement of from about 30° C. to about 60° C., but which is added in an amount such that the overall lipid composition has a melting point of from about 30° C. to about 60° C. In an aspect, the plant-sourced lipid composition may comprise an additional lipid that alone would not meet the above noted melting point requirement of from about 20° C. to about 40° C., but which is added in an amount such that the overall lipid composition has a melting point of from about 20° C. to about 40° C. In an aspect, the plant-sourced lipid composition may comprise an additional lipid that alone would not meet the above noted melting point requirement of from about 20° C. to about 36° C., but which is added in an amount such that the overall lipid composition has a melting point of from about 20° C. to about 36° C. In an aspect, the plant-sourced lipid composition may comprise an additional lipid that alone would not meet the above noted melting point requirement of from about 20° C. to about 30° C., but which is added in an amount such that the overall lipid composition has a melting point of from about 20° C. to about 30° C. The addition of such an added lipid may provide benefit in an organoleptic property such as flavor, color, moisture retention, or mouthfeel, or may provide benefit in processing by enhancing processability or as a less expensive ingredient may reduce overall cost of the plant-sourced lipid composition. In an aspect, the plant-sourced lipid composition additionally comprises a lipid selected from the group consisting of cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

In an aspect, the plant-sourced lipid composition may be formulated by selection of oils to have an Iodine Value of from about 15 to about 100. In an aspect, the plant-sourced lipid composition may be formulated to have an Iodine Value of from about 15 to about 80. In an aspect, the plant-sourced lipid composition may be formulated to have an Iodine Value of from about 15 to about 70. In an aspect, the plant-sourced lipid composition may be formulated to have an Iodine Value of from about 15 to about 50. In an aspect, the plant-sourced lipid composition may be formulated to have an Iodine Value of from about 50 to about 70.

For purposes of the present invention, “Iodine Value” is defined as the number of grams of iodine that will react with 100 grams of material being measured. Iodine value is a measure of the unsaturation (carbon-carbon double bonds and carbon-carbon triple bonds) present in a material. Iodine Value is reported in units of grams iodine (I₂) per 100 grams material and is determined using the procedure of AOCS Cd Id-92.

In an aspect, the plant-sourced lipid composition comprises one or more additional ingredients selected from flavorants (such as flavorants selected to provide a beef flavor, a pork flavor, a chicken flavor, a turkey flavor, and flavor ingredients selected to provide umami flavor sensation, and so on), colorant, preservative, water and mixtures thereof.

In an aspect, the plant-sourced lipid composition comprises oils and/or additional ingredients such that the plant-sourced lipid composition is solid at a temperature of 23° C. In an aspect, the plant-sourced lipid composition comprises components such that the plant-sourced lipid composition is solid at a temperature of 20° C. and melts at a temperature of 21° C. In an aspect, the plant-sourced lipid composition comprises components such that the plant-sourced lipid composition is solid at a temperature of 21° C. and melts at a temperature of 22° C. In an aspect, the plant-sourced lipid composition comprises components such that the plant-sourced lipid composition is solid at a temperature of 24° C. In an aspect, the plant-sourced lipid composition comprises components such that the plant-sourced lipid composition is solid at a temperature of 26° C.

In an aspect, the plant-sourced lipid composition is heated to a temperature above the melting point of the plant-sourced lipid composition and to a temperature of from about 24° C. to about 38° C. to provide a heated liquid lipid composition. In an aspect, the plant-sourced lipid composition is heated to a temperature above the melting point of the plant-sourced lipid composition and to a temperature of from about 26° C. to about 38° C. to provide a heated liquid lipid composition. In an aspect, the plant-sourced lipid composition is heated to a temperature above the melting point of the plant-sourced lipid composition and to a temperature of from about 28° C. to about 38° C. to provide a heated liquid lipid composition. In an aspect, the plant-sourced lipid composition is heated to a temperature above the melting point of the plant-sourced lipid composition and to a temperature of from about 30° C. to about 38° C. to provide a heated liquid lipid composition. In an aspect, the plant-sourced lipid composition is heated to a temperature above the melting point of the plant-sourced lipid composition and to a temperature of from about 32° C. to about 38° C. to provide a heated liquid lipid composition. In an aspect, the plant-sourced lipid composition is heated to a temperature above the melting point of the plant-sourced lipid composition and to a temperature of from about 34° C. to about 38° C. to provide a heated liquid lipid composition. In an aspect, the plant-sourced lipid composition is heated to a temperature above the melting point of the plant-sourced lipid composition and to a temperature of from about 26° C. to about 38° C. to provide a heated liquid lipid composition. In an aspect, the plant-sourced lipid composition is heated to a temperature above the melting point of the plant-sourced lipid composition and to a temperature of from about 24° C. to about 34° C. to provide a heated liquid lipid composition. In an aspect, the plant-sourced lipid composition is heated to a temperature above the melting point of the plant-sourced lipid composition and to a temperature of from about 28° C. to about 34° C. to provide a heated liquid lipid composition. In an aspect, the plant-sourced lipid composition is heated to a temperature above the melting point of the plant-sourced lipid composition and to a temperature of from about 30° C. to about 34° C. to provide a heated liquid lipid composition.

As shown in step 140 of FIG. 1, the liquid lipid composition is mixed with the chilled inulin gel composition to provide a lipid/inulin composition. In an aspect, the liquid lipid is added to the chilled inulin gel composition with mixing to provide a liquid lipid/inulin composition comprising from about 5 wt % to about 60 wt % inulin. In an aspect, the mixing process is started by placing the gel in the mixing apparatus such as a mixing bowl, and mixing the gel slowly at low shear, e.g. by hand with a whisk or other suitable apparatus. The liquid lipid composition in an aspect is then to the bowl while mixing to ensure that the gel and lipid are equally combined and mixed homogenously. In an aspect, the lipid is added to the gel as quickly as possible to facilitate mixing before the lipid solidifies to an extent that adversely affects homogeneous mixing.

In an aspect, the liquid lipid composition is mixed with inulin gel to provide a liquid lipid/inulin composition comprising from about 5% to about 60% inulin gel. In an aspect, the liquid lipid composition is mixed with inulin gel to provide a liquid lipid/inulin composition comprising from about 5% to about 20% inulin gel. In an aspect, the liquid lipid composition is mixed with inulin gel to provide a liquid lipid/inulin composition comprising from about 10% to about 50% inulin gel. In an aspect, the liquid lipid composition is mixed with inulin gel to provide a liquid lipid/inulin composition comprising from about 20% to about 40% inulin gel. In an aspect, the liquid lipid composition is mixed with inulin gel to provide a liquid lipid/inulin composition comprising from about 15% to about 30% inulin gel. In an aspect, the liquid lipid composition is mixed with inulin gel to provide a liquid lipid/inulin composition comprising from about 20% to about 30% inulin gel. In an aspect, the liquid lipid composition is mixed with inulin gel to provide a liquid lipid/inulin composition comprising from about 20% to about 50% inulin gel. In an aspect, the liquid lipid composition is mixed with inulin gel to provide a liquid lipid/inulin composition comprising from about 30% to about 50% inulin gel. In an aspect, the liquid lipid composition is mixed with inulin gel to provide a liquid lipid/inulin composition comprising from about 35% to about 45% inulin gel.

In an aspect, the lipid composition is selected and the liquid lipid composition is mixed with inulin gel at a lipid/inulin gel weight ratio such that the final crumble piece has a hardness at 4° C. of from about 650 g to about 950 g. In an aspect, the final crumble piece hardness at 4° C. is from about 700 g to about 900 g. In an aspect, the final crumble piece hardness at 4° C. is from about 750 g to about 850 g. In an aspect, the lipid composition is selected and the liquid lipid composition is mixed with inulin gel at a lipid/inulin gel weight ratio such that the final crumble piece has a hardness at −10° C. of from about 650 g to about 950 g. In an aspect, the final crumble piece hardness at −10° C. is from about 700 g to about 900 g. In an aspect, the final crumble piece hardness at −10° C. is from about 750 g to about 850 g.

For purposes of the present discussion, Hardness is determined by averaging measurement of 5 samples with a Stable Micro Systems TA.HD.Plus texture analyzer instrument with a TA-52 2 mm puncture probe at a probe speed of 2 mm/sec. The results are reported in grams.

While mixing, the temperature of the lipid/inulin composition is reduced in step 150 to a temperature such that the phase of the lipid/inulin composition changes from liquid to sufficiently solid that the lipid/inulin composition fractures into discrete plant-sourced lipid and inulin crumble pieces. In an aspect, the temperature of the lipid/inulin composition is reduced in step 150 to a temperature below about 13° C., with continued mixing until the lipid/inulin composition fractures into discrete plant-sourced lipid and inulin crumble pieces. In an aspect, the temperature reducing step 150 begins immediately upon combination of the liquid lipid composition with the optionally chilled inulin gel composition and initiation of mixing. The fracturing of the lipid/inulin composition into discrete plant-sourced lipid and inulin crumble pieces can be described as a progressive change of state of the materials, wherein the lipid/inulin composition begins to solidify and thicken, and due to the progressively colder temperatures the lipid/inulin composition becomes more prone to breaking into pieces, resulting in fracture of the lipid/inulin composition into discrete plant-sourced lipid and inulin crumble pieces. In an aspect, fracture of the lipid/inulin composition into discrete plant-sourced lipid and inulin crumble pieces occurs in a matter of seconds from initiation of the mixing and temperature reduction steps.

The temperature of the lipid/inulin composition may be reduced by any appropriate technique. In an aspect, the temperature of the lipid/inulin composition is reduced by use of a chilled jacketing component as part of the mixing apparatus. In an aspect, the chilled jacketing component uses chilled water or glycol as the coolant. In an aspect, the temperature of the lipid/inulin composition is reduced by introduction of food safe cryogenic materials to the mixing apparatus in order to provide the desired reduction in temperature. In an aspect, the food safe cryogenic material is dry ice (i.e., cooled and condensed carbon dioxide) or liquid nitrogen.

In an aspect, temperature of the lipid/inulin composition is be reduced to a temperature of from about −15° C. to about 13° C. to ensure the lipid/inulin composition will fracture to the desired particle sizes and characteristics. In an aspect, temperature of the lipid/inulin composition is be reduced to a temperature of from about −10° C. to about 13° C. to ensure the lipid/inulin composition will fracture to the desired particle sizes and characteristics. In an aspect, temperature of the lipid/inulin composition is be reduced to a temperature of from about −5° C. to about 13° C. to ensure the lipid/inulin composition will fracture to the desired particle sizes and characteristics. In an aspect, temperature of the lipid/inulin composition is be reduced to a temperature of from about 0° C. to about 10° C. In an aspect, temperature of the lipid/inulin composition is be reduced to a temperature of from about 0° C. to about 8° C. In an aspect, temperature of the lipid/inulin composition is reduced to a temperature of from about 0° C. to about 5° C.

In an aspect, the lipid/inulin composition is cooled at a cooling rate of from about 1° C./minute to about 5° C./minute.

In an aspect, the lipid/inulin composition is cooled while stirring in a mixing apparatus comprising a stirring impeller. In an aspect, the lipid/inulin composition is cooled while stirring with a stirring device selected from a mixer fitted with a beater, paddle or a whip, a swept surface head exchanger (SSHE), and a ribbon mixer. In an aspect, the lipid/inulin composition is cooled while stirring with a stirring impeller that comprises blades that also perform a cutting function on the lipid/inulin composition as it fractures into discrete plant-sourced lipid and inulin crumble pieces. In an aspect, the same mixing apparatus is used from preparing the inulin gel and for mixing the lipid/inulin composition.

In an aspect, the mixing apparatus is a food chopper. For purposes of the present description, a food chopper is a food cutter having a flat surface for receiving food to be cut, and one or more vertically movable cutting blades configured to chop the plant-sourced lipid composition into crumble pieces.

In an aspect, the mixing apparatus is a bowl chopper. For purposes of the present description, a bowl chopper is a food cutter having a rotary bowl for receiving food to be cut, and one or more vertically oriented blades (also described as “knives” in the art) attached to a horizontally oriented rotary knife shaft. The rotary bowl rotates around a vertical axis, and the blades cut by rotation of the horizontally oriented rotary knife shaft. The blades are aligned relative to the internal wall or walls of the bowl such that they may chop and mix the food within the bowl. While the lateral position of the rotary knife shaft is substantially stationary, the bowl and the contents therein rotate relative to the blades whereby the contents are continuously moved against the blades as the bowl is rotating. In an aspect, the blades may be run in only a forward direction, or in an aspect run in both a forward direction and a reverse direction. Bowl choppers are commercially available, and are described, for example, in U.S. Pat. No. 5,996,917, the disclosure of which is incorporated herein by reference. The use of a bowl chopper in the present process is particularly advantageous, because it efficiently performs a cutting function on the lipid/inulin composition as it fractures into discrete plant-sourced lipid and inulin crumble pieces.

In an aspect, the mixing apparatus is a food processor. For purposes of the present description, a food processor is a food cutter having a food container for receiving food to be cut that is fitted with a hub configured to be coupled to a drive shaft of the food processor. One or more blades are rotatably coupled to the hub. In the case of the food processor, the blades are horizontally oriented, and the hub and drive shaft are generally vertically oriented. In an aspect, the blades may be run in only a forward direction, or in an aspect run in both a forward direction and a reverse direction. Food processors are commercially available, and are described, for example, in U.S. Pat. No. 7,054,348, the disclosure of which is incorporated herein by reference.

In an aspect, the lipid/inulin composition is cooled while stirring, and discrete pieces are formed by loading the lipid/inulin composition in a pumpable state in a hopper and depositing aliquots on a chilled belt using nozzles.

In an aspect, the discrete plant-sourced lipid and inulin crumble pieces prepared by this method have a particle size such that at least 90% of the crumble pieces have a particle size of from 1.5 mm to 26 mm. In an aspect, at least 90% of the crumble pieces have a particle size of from 3 mm to 13 mm. In an aspect, at least 90% of the discrete plant-sourced lipid and inulin crumble pieces have a particle size of from 3 mm to 8 mm.

In an aspect, at least 90% of the discrete plant-sourced lipid and inulin crumble pieces have a particle size of from 1.5 mm to 26 mm and at least 50% of the crumble pieces have a particle size of from 3 mm to 8 mm. In an aspect, at least 90% of the crumble pieces have a particle size of from 1.5 mm to 26 mm and at least 60% of the crumble pieces have a particle size of from 3 mm to 8 mm. In an aspect, at least 90% of the crumble pieces have a particle size of from 1.5 mm to 26 mm and at least 70% of the crumble pieces have a particle size of from 3 mm to 8 mm. In an aspect, at least 90% of the crumble pieces have a particle size of from 1.5 mm to 26 mm and at least 80% of the crumble pieces have a particle size of from 3 mm to 8 mm. In an aspect, at least 95% of the crumble pieces have a particle size of from 1.5 mm to 26 mm and at least 50% of the crumble pieces have a particle size of from 3 mm to 8 mm. In an aspect, at least 95% of the crumble pieces have a particle size of from 1.5 mm to 26 mm and at least 60% of the crumble pieces have a particle size of from 3 mm to 8 mm. In an aspect, at least 95% of the crumble pieces have a particle size of from 1.5 mm to 26 mm and at least 70% of the crumble pieces have a particle size of from 3 mm to 8 mm. In an aspect, at least 95% of the crumble pieces have a particle size of from 1.5 mm to 26 mm and at least 80% of the crumble pieces have a particle size of from 3 mm to 8 mm. In an aspect, at least 95% of the crumble pieces have a particle size of from 1.5 mm to 26 mm and at least 90% of the crumble pieces have a particle size of from 3 mm to 8 mm.\

In an aspect, the discrete plant-sourced lipid and inulin crumble pieces are stored at a temperature of from about 0° C. to about 5° C. In an aspect, the discrete plant-sourced lipid and inulin crumble pieces are stored at a temperature of from about −20° C. to about 0° C. In an aspect, the discrete plant-sourced lipid and inulin crumble pieces are stored at a temperature of from about −20° C. to about −10° C.

In an aspect, an anti-agglomerate may be applied to the discrete plant-sourced lipid and inulin crumble pieces to prevent undue agglomeration of the crumble pieces before mixing with the protein composition. This aspect may be beneficial in the event that the discrete plant-sourced lipid and inulin crumble pieces is to be stored in particle form for some time before mixing with the protein composition. In an aspect, no anti-agglomerate may be applied to the discrete plant-sourced lipid and inulin crumble pieces. This aspect is beneficial in reducing the number of additives incorporated in to the product, advantageously reducing cost and also simplifying the ingredient list that must be reported to customers. It has been found to be desirable in particular in the food industry to provide products having a “clean label” where possible, which is valued by many consumers.

In an aspect, the discrete plant-sourced lipid and inulin crumble pieces are maintained at a temperature of from about from about −15 to about 4.5° C. It has been found that the water activity of the discrete plant-sourced lipid and inulin crumble pieces is too high to consider these products shelf stale. Therefore, it is advantageous to maintain the discrete plant-sourced lipid and inulin crumble pieces at refrigerated temperature or under cold conditions until used as a single ingredient in meat mimetic or meat hybrid products.

In an aspect, the process further comprising the step of freezing the discrete plant-sourced lipid and inulin crumble pieces. In an aspect, the discrete plant-sourced lipid and inulin crumble pieces may be frozen using any appropriate technique. In an aspect, the discrete plant-sourced lipid and inulin crumble pieces are frozen by an IQF process (“individually quick frozen”) to prevent agglomeration of the discrete plant-sourced lipid and inulin crumble pieces.

In an aspect, the discrete plant-sourced lipid and inulin crumble pieces comprise a plant-sourced lipid composition having a melting point of from about 20° C. to about 36° C. and an inulin gel. In an aspect, the discrete plant-sourced lipid and inulin crumble pieces comprise lipid mixed with inulin gel at a lipid/inulin gel weight ratio of from about 20 to about 60 wt %. In an aspect, the lipid is mixed with inulin gel at a lipid/inulin gel weight ratio of from about 30 to about 50 wt %. In an aspect, the lipid is mixed with inulin gel at a lipid/inulin gel weight ratio of from about 35 to about 45 wt %. In an aspect, the inulin gel is a mixture of inulin with water at an inulin/water weight ratio of from about 5 to about 35. In an aspect, the inulin/water weight ratio is from about 10 to about 30 wt %. In an aspect, the inulin/water weight ratio is from about 15 to about 25 wt %.

In an aspect, the discrete plant-sourced lipid and inulin crumble pieces comprises from about 30 wt % to about 40 wt % of water. In an aspect, the discrete plant-sourced lipid and inulin crumble pieces have a water activity of from about 0.8 to about 1.1.

In an aspect, the discrete plant-sourced lipid and inulin crumble pieces comprises from about 0.1 to about 6 wt % of fiber. In an aspect, the discrete plant-sourced lipid and inulin crumble pieces comprises from about 3 to about 4 wt % of fiber.

In an aspect, the discrete plant-sourced lipid and inulin crumble pieces exhibit an average color value of an L* color value of from about 85 to 98, an “a*” color value between about −1.5 and 1.5, and a “b*” color value between about 5 and 20. In aspect, the discrete plant-sourced lipid and inulin crumble pieces exhibit an average color value of an L* color value of from about 88 to 95, an “a*” color value between about −1 and 0, and a “b*” color value between about 8 and 12.

The color measurements are determined as an average of three scans made by a Hunter Labscan XE instrument using a CIE Standard Illuminant D65/10 degrees. The testing is carried out by compressing the crumbles into the bottom of a 1.75″ diameter glass vessel cup using flat cylinder shaped press.

In an aspect, the plant-sourced lipid and inulin crumble pieces are free of animal sourced ingredients.

In an aspect, a process of preparing an animal meat mimetic comprises mixing a plant protein composition with water to form a composition comprising hydrated plant protein and mixing the composition comprising hydrated plant protein with the plant-sourced lipid and inulin crumble pieces as described herein under chilling conditions at a temperature low enough to maintain the particulate nature of the plant-sourced lipid and inulin crumble pieces to form an animal meat mimetic.

In an aspect, the plant protein used in the present process may be selected from one or more of legume, alfalfa, chia, clover, pea, chickpea, cow pea, earth pea, sweet pea, pigeon pea, bean, broad bean, kidney bean, mung bean, navy bean, soy, lentil, lupin, mesquite, cocoa, carob, nut, peanut, almond, potato, gluten, cereal, maize, rice, wheat, wheat gluten, barley, sorghum, millet, oat, rye, triticale, buckwheat, fonio, quinoa, hemp, fungal, algal, or seaweed protein. In an aspect, the plant protein used in the present process may be selected from soy or pea protein.

In an aspect, the plant protein composition comprises plant protein in the form of a protein concentrate. In an aspect, the plant protein composition comprises plant protein in the form of a protein isolate.

In an aspect, the plant protein used in the present process is a powdered plant protein having a particle size range of from about 20 to about 300 μm. In an aspect, the plant protein used in the present process is a textured plant protein having a particle size range of from about 0.2 to about 20 mm.

The plant protein is hydrated by mixing the plant protein composition with water in any appropriate vessel, such as a mixer or blender. In an aspect, water is mixed with the plant protein composition in a water:(protein composition) weight ratio of from about 2:1 to about 4:1. In an aspect, water is mixed with the plant protein composition in a water:(protein composition) weight ratio of about 3:1.

In an aspect, the composition comprising hydrated plant protein comprises an additional ingredient selected from flavorant, colorant, preservative (i.e. an ingredient to prevent or retard micro growth and/or spoilage), fiber, vitamins, minerals, and binders (hydrocolloids).

In an aspect, the composition comprising hydrated plant protein comprises flavor ingredients selected to mimic the flavor of beef. In an aspect, the composition comprising hydrated plant protein comprises flavor ingredients selected to mimic the flavor of pork. In an aspect, the composition comprising hydrated plant protein comprises flavor ingredients selected to mimic the flavor of chicken. In an aspect, the composition comprising hydrated plant protein comprises flavor ingredients selected to mimic the flavor of turkey. In an aspect, the composition comprising hydrated plant protein comprises flavor ingredients selected to provide umami flavor sensation.

In an aspect, any of the desired added ingredients may be added to the dry plant protein composition, or to the hydration water or both.

The composition comprising hydrated plant protein is then mixed with the plant-sourced lipid and inulin crumble pieces as described herein under chilling conditions at a temperature low enough to maintain the particulate nature of the plant-sourced lipid and inulin crumble pieces to prepare an animal meat mimetic. In an aspect, the composition comprising hydrated plant protein is pre-chilled to a temperature of from about 0° C. to about 10° C. before mixing with the particulate plant-sourced lipid and inulin crumble pieces. In an aspect, combined plant protein/particulate compositions mix is chilled by addition of dry ice (i.e. cooled and condensed carbon dioxide) before and/or during the mixing step. In an aspect, the combined plant protein/particulate compositions mix is chilled by addition of liquid nitrogen before and/or during the mixing step.

In an aspect, the combined plant protein/particulate compositions mix is maintained at a temperature less than 10° C. during the mixing step. In an aspect, the combined plant protein/particulate compositions mix is maintained at a temperature less than 0° C. during the mixing step. In an aspect, the combined plant protein/particulate compositions mix is maintained at a temperature of from about 0° C. to about 10° C. during the mixing step.

Mixing of the composition comprising hydrated plant protein with the particulate plant-sourced lipid and inulin crumble pieces may be carried out in the same or a different mixing device as used to mix the plant protein with water to form a composition comprising hydrated plant protein. Any suitable mixing device may be used to prepare mixed product, such as a blender. In an aspect, the mixing device uses an impeller such as a paddle blender, to prepare the animal meat mimetic product. The mixer in an aspect does not impart excess pressure to the mixture, as this would result in an overly dense product that does not meet texture expectations. In an aspect, the mixing is not carried out in an extruder exerting 1.5 MPa or more of pressure.

In an aspect, a process of preparing an animal meat mimetic comprises mixing a plant protein composition with water to form a composition comprising hydrated plant protein and mixing the composition comprising hydrated plant protein with the discrete plant-sourced lipid and inulin crumble pieces as described herein under chilling conditions at a temperature low enough to maintain the particulate nature of the solid lipid composition to form an animal meat mimetic.

In an aspect, the plant protein used in the present process may be selected from one or more of legume, alfalfa, chia, clover, pea, chickpea, cow pea, earth pea, sweet pea, pigeon pea, bean, broad bean, kidney bean, mung bean, navy bean, soy, lentil, lupin, mesquite, cocoa, carob, nut, peanut, almond, potato, gluten, cereal, maize, rice, wheat, wheat gluten, barley, sorghum, millet, oat, rye, triticale, buckwheat, fonio, quinoa, hemp, fungal, algal, or seaweed protein. In an aspect, the plant protein used in the present process may be selected from soy or pea protein.

In an aspect, the plant protein composition comprises plant protein in the form of a protein concentrate. In an aspect, the plant protein composition comprises plant protein in the form of a protein isolate.

The plant protein is hydrated by mixing the plant protein composition with water in any appropriate vessel, such as a mixer or blender. In an aspect, water is mixed with the plant protein composition in a water:(protein composition) weight ratio of from about 2:1 to about 4:1. In an aspect, water is mixed with the plant protein composition in a water:(protein composition) weight ratio of about 3:1.

In an aspect, the hydrated plant protein composition comprises an additional ingredient selected from flavorant, colorant, preservative (i.e. an ingredient to prevent or retard micro growth and/or spoilage), fiber, and hydrocolloids (such as methylcellulose and starches).

In an aspect, the hydrated plant protein composition comprises flavor ingredients selected to mimic the flavor of beef. In an aspect, the hydrated plant protein composition comprises flavor ingredients selected to mimic the flavor of pork. In an aspect, the hydrated plant protein composition comprises flavor ingredients selected to mimic the flavor of chicken. In an aspect, the hydrated plant protein composition comprises flavor ingredients selected to mimic the flavor of turkey.

In an aspect, any of the desired added ingredients may be added to the dry plant protein composition, or to the hydration water or both.

Any suitable mixing device may be used to prepare the hydrated plant protein composition. In an aspect, the mixing device uses an impeller such as a paddle blender. In an aspect, the mixing device is a food cutting device as described above.

The hydrated plant protein composition is then mixed with the discrete plant-sourced lipid and inulin crumble pieces as described herein under chilling conditions at a temperature low enough to maintain the particulate nature of the solid lipid composition to prepare an animal meat mimetic. In an aspect, hydrated plant protein composition is pre-chilled to a temperature of from about 0° C. to about 10° C. before mixing with the discrete plant-sourced lipid and inulin crumble pieces. In an aspect, combined plant protein/particulate compositions mix is chilled by addition of dry ice (i.e. cooled and condensed carbon dioxide) before and/or during the mixing step. In an aspect, the combined plant protein/particulate compositions mix is chilled by addition of liquid nitrogen before and/or during the mixing step.

In an aspect, the combined plant protein/particulate compositions mix is maintained at a temperature less than 10° C. during the mixing step. In an aspect, the combined plant protein/particulate compositions mix is maintained at a temperature less than 0° C. during the mixing step. In an aspect, the combined plant protein/particulate compositions mix is maintained at a temperature of from about 0° C. to about 10° C. during the mixing step.

Any suitable mixing device may be used to prepare mixed product. In an aspect, the mixing device uses an impeller such as a paddle blender, to prepare the animal meat mimetic product. In an aspect, the mixing device is a food cutting device as described above. In an aspect, the mixing device does not impart excess pressure to the mixture, as this would result in an overly dense product that does not meet texture expectations. In an aspect, the mixing is not carried out in an extruder exerting 1.5 MPa or more of pressure.

In an aspect, the hydrated plant protein composition is mixed with the discrete plant-sourced lipid and inulin crumble pieces using a mixing device that is a food cutting device as described above.

In an aspect, the discrete plant-sourced lipid and inulin crumble pieces are mixed with the protein composition directly after formation of the crumble pieces. This aspect provides significant benefits in that the crumble pieces retain their uniformity and consistency, which is advantageous for effective distribution in the hydrated plant protein composition. In this aspect, by preparation of the combined plant protein/particulate composition is a short time frame (e.g. within 24 hours or within 8 hours of preparation of the discrete plant-sourced lipid and inulin crumble pieces) a further benefit may be realized by avoiding the use of such as anti-agglomerate additive materials that may inhibit interaction of the lipid with the protein composition as the final product is heated for consumption.

In an aspect, the hydrated plant protein composition is mixed with the discrete plant-sourced lipid and inulin crumble pieces sequentially in the same mixing device as used to mix the plant protein with water to form a hydrated plant protein composition.

In an aspect, the hydrated plant protein composition is mixed with the discrete plant-sourced lipid and inulin crumble pieces sequentially in the same mixing device as used to prepare the discrete plant-sourced lipid and inulin crumble pieces.

In an aspect, the animal meat mimetic is a ground meat mimetic product. In an aspect, the animal meat mimetic is a ground beef mimetic product. In an aspect, the animal meat mimetic is a ground pork mimetic product. In an aspect, the animal meat mimetic is a ground chicken mimetic product. In an aspect, the animal meat mimetic is a ground turkey mimetic product. In an aspect, the animal meat mimetic is a breakfast patty product. In an aspect, the animal meat mimetic is a meatball product.

In an aspect, a hybrid food product is prepared by mixing a protein composition comprising animal protein with the plant-sourced lipid and inulin crumble pieces as described herein under chilling conditions at a temperature low enough to maintain the particulate nature of the plant-sourced lipid and inulin crumble pieces to form a hybrid product. In an aspect, the animal protein is a prepared by reducing the amount of animal-sourced fat associated with the protein, so that the final product in an aspect is a reduced animal-sourced fat, or is in an aspect reduced in overall fat normally associated with the product. In an aspect, the hybrid food product additionally comprises animal fat.

In an aspect, the animal meat mimetic product is mixed with actual animal products, such as ground beef, ground turkey, ground chicken and the like to form a hybrid animal protein product. Advantageously, the hybrid product provides excellent flavor and texture properties while at the same time reducing the amount of animal product present in a given food. Hybrid animal protein products containing a substantial amount of the present animal meat mimetic product (e.g. from 20 to 80%, or from 30-60%, or from 35-55% plant protein based on all protein in the product) advantageously provides a different protein identity distribution from animal sourced meat products, thereby providing nutrition and health benefits. Additionally, vegetable sourced proteins may be less expensive and less resource demanding during production than animal sourced proteins, thereby reducing the overall cost of the final product without sacrificing flavor.

In an aspect, the animal meat mimetic product or the hybrid product is provided in a bulk format. In an aspect, the animal meat mimetic product or the hybrid product is provided in overwrapped trays. This package type features air permeable overwrap with animal meat mimetic product or the hybrid product placed on an absorbent pad in a foam or plastic tray, packaging. In an aspect, the animal meat mimetic product or the hybrid product is provided in a case ready tray, wherein the animal meat mimetic product or the hybrid product is packaged and sealed at the manufacturing facility in a plastic-lidded package. In an aspect, the product is provided in chubs, wherein the animal meat mimetic product or the hybrid product is packaged in a tube-like package. In an aspect, the animal meat mimetic product or the hybrid product is packaged in any such format in sizes of 1 lb., 2 lb., 3 lb., 5 lb. and 10 lb.

In an aspect, the animal meat mimetic product or the hybrid product is used to prepare any final food products that one might prepare using a ground meat product, such as burgers, meat loaf, meatballs, sausages, and the like.

### Examples

### Example 1. Plant-Sourced Lipid and Inulin Crumble Pieces Comprising Coconut Oil

### A. Preparation of Inulin Gel

Inulin and water were mixed at a ratio of 20/80 (wt %) to form a slurry and heated to a temperature of about 85° C. on high shear in a Thermomix® mixer for 15 minutes and allowed to cool in shallow containers overnight. The slurry was cooled to a temperature of about 4° C. to form a gel.

### B. Preparation of Coconut Oil and Inulin Crumble Pieces

Coconut Oil RBD 76 was melted by heating to 39° C.

### C. Mixing

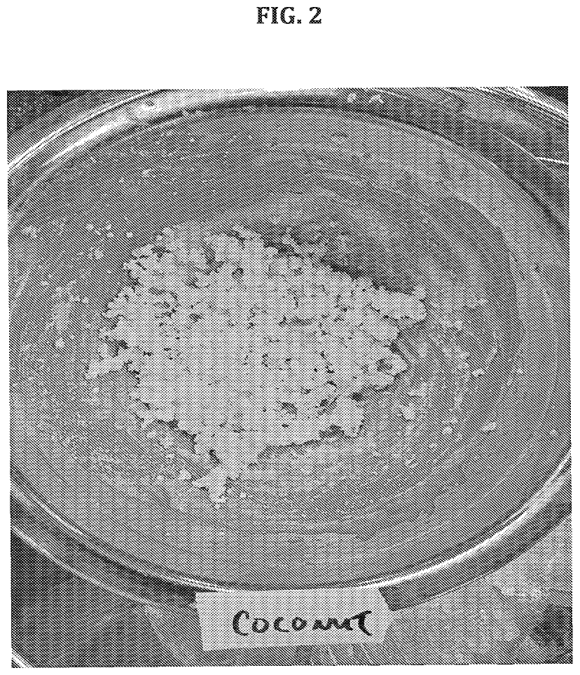

The melted Coconut Oil was added to the chilled inulin gel to provide an inulin gel content of 40%, with mixing by hand with a whisk. In this laboratory experiment, the combined composition was mixed in a bowl that was on top of a bowl of ice to emulate a chilled water jacket. In the process of mixing and cooling, the resulting lipid/inulin composition first thickened and then solidified to an extent to break apart into small pieces as the temperature of the composition was reduced. The resulting plant-sourced lipid and inulin crumble pieces are of the proper size and general appearance, as shown in FIG. 2. The lab prepared pieces were found to be somewhat sticky and would not provide proper consistency during processing. However, it was found that by chilling the lipid/inulin composition more quickly and to a lower temperature, suitable Crumble Pieces with better consistency and stability may be prepared. For example, it was found that such oil/inulin compositions turn into a thick frosting-like consistency at about 17° C. (64° F.) and begin to break apart into small pieces or beads at about 13° C. (55° F.). Rapid, complete cooling and mixing results in formation of Crumble Pieces with excellent consistency and stability properties. The cooling temperatures and cooling rates in combination with mixing conditions may be adapted in response to the lipid selection and lipid/inulin ratio to formulate Crumble Pieces exhibiting excellent performance in stability, texture, processability, and organoleptic characteristics.

### Example 2-Plant-Sourced Lipid and Inulin Crumble Pieces Comprising Cocoa Butter

### A. Preparation of Inulin Gel

Inulin and water were mixed at a ratio of 20/80 (wt %) to form a slurry and heated to a temperature of 80° C. on high shear in a Thermomix® mixer for 15 minutes and allowed to cool in shallow containers overnight. The slurry was cooled to a temperature of about 4° C. to form a gel. The slurry was cooled to a temperature of about 4° C. to form a gel.

### B. Preparation of Cocoa Butter and Inulin Crumble Pieces

Cocoa butter was heated to a temperature of 50° C. to form a liquid, cooled to a temperature of 38° C. and added as 1 part cocoa butter to 1 parts inulin gel in a bowl with vigorous stirring to provide an inulin gel content of 50%. In this laboratory experiment, the combined composition was mixed in a bowl that was on top of a bowl of ice to emulate a chilled water jacket. The resulting lipid/inulin composition began to solidify or crystallize at about 17° C. (64° F.) and turned into a thick frosting, which then began to firm and became very brittle at about 13° C. (55° F.). Stirring continued until the pea sized pieces were formed. The resulting plant-sourced lipid and inulin Crumble Pieces are firm and appear to be discrete and stable. The Crumble Pieces melt smoothly when held in the hand.

The Plant-sourced lipid and inulin Crumble Pieces were frozen by an IQF process to form IQF Cocoa Butter Plant-sourced lipid and inulin crumble pieces having an average particle size of about 0.25 mm to 2.5 mm.

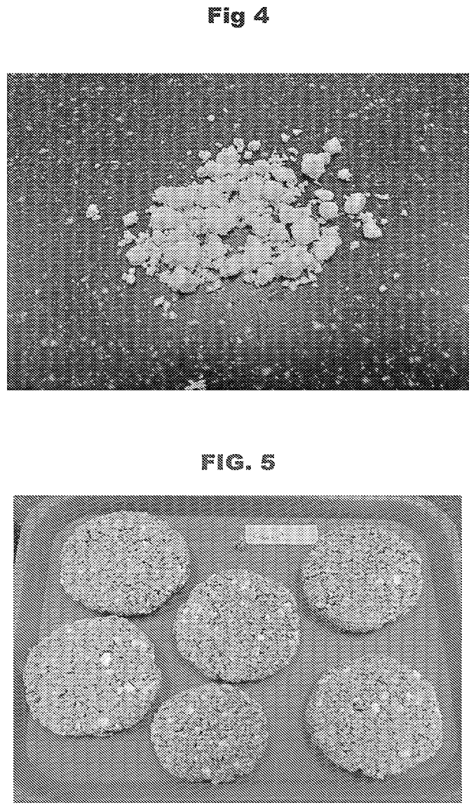

The Plant-sourced lipid and inulin Crumble Pieces are shown in FIG. 4

### Example 3 Vegan Breakfast Sausage Patty

A vegan breakfast sausage patty is formulated using the recipe as set forth in Table 1 with the Lipid and Inulin Crumble Pieces Comprising Cocoa Butter of Example 2.

TABLE 1
Vegan Breakfast Sausage Patty

| Ingredient Description | % WT | Grams |
|---|---|---|
| Water - first portion | 20.000% | 160.000 |
| Water to Hydrate TPP - | 41.850% | 334.800 |
| second portion | | |
| Textured Pea Protein | 15.700% | 125.600 |
| (“TPP”)- Puris | | |
| Methylcellulose | 2.000% | 16.000 |
| Puris Pea protein 870 | 2.000% | 16.000 |
| Breakfast seasoning | 2.150% | 17.200 |
| Salt | 1.600% | 12.800 |
| Coconut oil - separate lipid | 8.000% | 64.000 |
| ingredient | | |
| IQF Cocoa butter: inulin gel | 6.500% | 52.000 |
| of Example 2 above. | | |
| Brilliant Red food coloring | 0.200% | 1.600 |
| Salt | 1.600% | 12.800 |
| Total | 100.00% | 800.00 |

The sausage patty was prepared by the following process:

Dry ingredients other than TPP were blended by mixing in a Robo coupe food processor.

Solid coconut oil cut was in pieces and added to dry ingredients.

The first portion of water was added to the Robo coupe food processor, and the composition was mixed on Pulse until the mass began to fold on itself and became homogenous to form an intermediate matrix blend.

The TPP was hydrated by addition of the second portion of water in a mixer, and the combination was colored with the Brilliant Red colorant to form a colored protein composition.

The intermediate matrix blend was added to the colored protein composition in the mixer, and the combination was mixed on low for 2-3 minutes until incorporated.

The IQF Cocoa Butter Plant-sourced lipid and inulin crumble pieces was added to the mixer and the combination was mixed until well incorporated.

35 g portions of this composition were formed into 3/16″ thick 3″ diameter patties.

The resulting Vegan Breakfast Sausage Patties were seared on both sides in a pan and cooked to 165° F. The patties were then frozen.

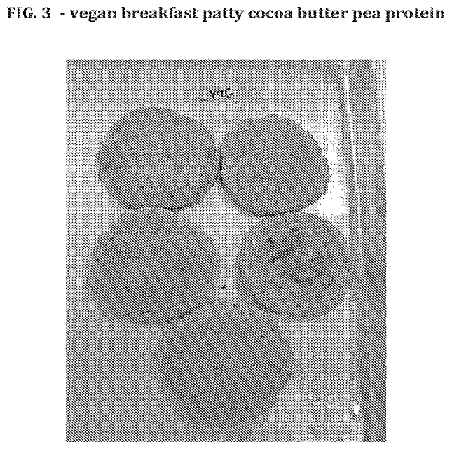

The thus prepared patties are shown in FIG. 3.

### Observations

Prior to cooking, the crumble pieces comprising plant-sourced lipid and inulin exhibited a pleasing white appearance that were readily visually apparent in the sausage patties due to the contrast with the dark matrix of the protein. After cooking, the sausage patties exhibited a noticeably high level of moisture and juiciness, providing excellent organoleptic benefits.

### Example 4 Vegan Beef-Type Burger with IFQ Coconut Oil Chips-COMPARATIVE

A vegan beef-type burger is formulated using the recipe as set forth in Table 2 below using fat chips made from coconut oil by a conventional process of pouring coconut oil in a mold, freezing to solidify the oil and mechanically chopping the frozen oil to form frozen coconut oil chips of the same target size of the Crumble Pieces of Example 2, i.e. pieces having an average particle size of about 0.25 mm to 2.5 mm.

TABLE 2
Vegan Beef-Type Burger Recipe

| Ingredient Description | % WT | Grams |
|---|---|---|
| Water - first portion | 20.000% | 130.000 |
| “Matrix water” | | |
| Water to Hydrate TPP - | 43.300% | 281.450 |
| second portion | | |
| Textured Pea Protein | 17.000% | 110.500 |
| (“TPP”)- Puris | | |
| Puris Pea protein 870 | 2.000% | 13.000 |
| Methylcellulose | 1.200% | 7.800 |
| Salt | 0.400% | 2.600 |
| IQF Coconut oil chips | 12.000% | 78.000 |
| Natural Flavor/meaty flavor | 1.210 | 7.865 |
| (Sensient) | | |
| Umami Flavor - | 0.250 | 1.625 |
| TasteNRich B5 | | |
| Umami Flavor - | 0.080 | 0.520 |
| TasteNRich L5 | | |
| Dextrose | 0.660 | 4.290 |
| Red food coloring | 1.500 | 9.750 |
| KCL | 0.200 | 1.300 |
| Total | 100.00% | 650.00 |

### Vegan Beef-Type Burger Formation Process:

Textured Pea Protein (“TPP”) hydration water was colored with beet powder.

TPP was hydrated with colored TPP hydration water to form colored hydrated TPP.

Matrix water was provided in the form of ice water (i.e. about −1 to 0° C.), and weighed to desired quantity.

All dry ingredients were blended and placed in cooler to lower the temperature to provide a chilled dry blend.

The chilled dry blend was hydrated with the Matrix water in a mixer until it folds on itself.

The resulting matrix was added to the colored hydrated TPP and mixed to form a.

The resulting homogenous TPP matrix was chilled in a blast freezer to a temperature of 40° F.

Coconut oil chips were added, and patties were formed of size 113 g, 0.65-0.75 inches thick formed and frozen.

Frozen patties were fried, browning the patties on both sides until 73.9° C. (165° F.) internal temperature is reached.

FIG. 5 is a photograph of vegan beef type patties prepared comprising coconut oil but not containing inulin according to this example.

### Example 5 Vegan Beef-type Burger with Lipid Crumble Pieces Comprising Cocoa Butter and Inulin

A vegan beef-type burger is formulated using the recipe as set forth in Table 3 with the Lipid and Inulin Crumble Pieces Comprising Cocoa Butter and Inulin of Example 2

TABLE 3
Vegan Beef-Type Burger Recipe

| Ingredient Description | % WT | Grams |
|---|---|---|
| Water - first portion | 20.000% | 130.000 |
| “Matrix water” | | |
| Water to Hydrate TPP - | 43.300% | 281.450 |
| second portion | | |
| Textured Pea Protein | 17.000% | 110.500 |
| (“TPP”)- Puris | | |
| Puris Pea protein 870 | 2.000% | 13.000 |
| Methylcellulose | 1.200% | 7.800 |
| Salt | 0.400% | 2.600 |
| Coconut oil: inulin gel | 12.000% | 78.000 |
| Crumble Pieces of Example | | |
| 2 | | |
| Natural Flavor/meaty flavor | 1.210 | 7.865 |
| (Sensient) | | |
| Umami Flavor - | 0.250 | 1.625 |
| TasteNRich B5 | | |
| Umami Flavor - | 0.080 | 0.520 |
| TasteNRich L5 | | |
| Dextrose | 0.660 | 4.290 |
| Red food coloring | 1.500 | 9.750 |
| KCL | 0.200 | 1.300 |
| Total | 100.00% | 650.00 |

The Vegan beef-type burgers were formed in the same process described in Example 4 above.

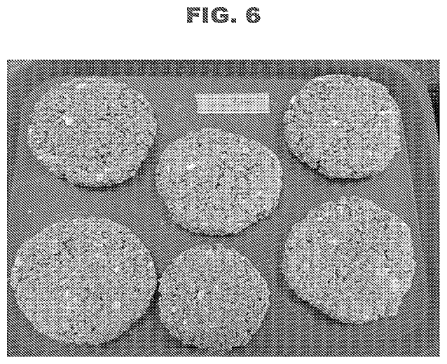

FIG. 6 is a photograph of vegan beef type patties prepared comprising Lipid and Inulin Crumble Pieces Comprising Cocoa Butter and Inulin according to this example.

### Observations Regarding Examples 4 and 5.

The vegan beef-type burgers of both examples 4 and 5 exhibited good overall appearance and texture, with a neutral flavor with no lingering undesirable aftertaste or pea flavor.

The vegan beef-type burgers of Example 5 had a higher moisture content due to incorporation of inulin in the Lipid and Inulin Crumble Pieces. As a result the vegan beef-type burgers of Example 5 were more moist and less dry from an organoleptic perspective, providing a noticeable succulence benefit. Moreover, the burgers of Example 5 had 50% less calorie contribution from lipid and 50% less saturated fat from lipid as compared to like burgers that did not incorporate inulin. Incorporation of inulin with the lipid as described was demonstrated to provide excellent processability while retaining the desired lipid flavor profile. Additionally, incorporation of inulin as described permits use of more expensive lipid materials at an acceptable cost point without sacrifice of performance.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1-39. (canceled)

40. A process of preparing crumble pieces comprising plant-sourced lipid and inulin comprising:
mixing a plant-sourced lipid composition in liquid form with an inulin gel composition to provide a liquid lipid/inulin composition comprising from about 5% to about 60% inulin gel; and
reducing the temperature of the liquid lipid/inulin composition with continued mixing to a temperature such that the phase of the lipid/inulin composition changes from liquid to sufficiently solid that the lipid/inulin composition fractures into discrete plant-sourced lipid and inulin crumble pieces.

41. The process of claim 40, wherein the plant-sourced lipid composition is mixed with the inulin gel composition to provide a liquid lipid/inulin composition comprising from about 10% to about 50% inulin gel.

42. The process of claim 40, wherein at least 90% of the discrete plant-sourced lipid and inulin crumble pieces have a particle size of from 1.5 mm to 26 mm.

43. The process of claim 40, wherein the plant-sourced lipid composition has a melting point of from about 20° C. to about 60° C.

44. The process of claim 40, wherein the plant-sourced lipid composition comprises fats and/or additional ingredients such that the plant-sourced lipid composition is solid at a temperature of 23° C.

45. The process of claim 40, wherein the inulin has a chain length of 3 to 60 sugar units.

46. The process of claim 40, wherein the inulin gel composition is prepared by mixing inulin with water at an inulin/water weight ratio of from about 5 to about 35 and allowing the gel to form.

47. The process of claim 40, wherein the inulin gel composition is cooled to a temperature of from about 0° C. to about 4.5° C. to provide a chilled inulin gel composition prior to mixing with the plant-sourced lipid composition.

48. The process of claim 40, wherein the plant-sourced lipid composition is heated to a temperature that is above the melting point of the plant-sourced lipid composition and below a temperature of about 38° C. to provide the plant-sourced lipid composition in liquid form.

49. The process of claim 48, wherein the plant-sourced lipid composition has a melting point of from about 20° C. to about 36° C.

50. The process of claim 40, wherein the step of reducing the temperature of the lipid/inulin composition comprises reducing the temperature to below about 13° C., with mixing until the lipid/inulin composition fractures into the discrete plant-sourced lipid and inulin crumble pieces.

51. The process of claim 40, wherein the mixing is carried out by a mixing apparatus comprising a stirring impeller that comprises blades.

52. The process of claim 40, further comprising the step of freezing the discrete plant-sourced lipid and inulin crumble pieces.

53. Plant-sourced lipid and inulin crumble pieces prepared by the process of claim 40.

54. Plant-sourced lipid and inulin crumble pieces comprising
a plant-sourced lipid composition and an inulin gel having a lipid/inulin gel weight ratio of from about 5 wt % to about 60 wt % in the form of discrete plant-sourced lipid and inulin crumble pieces, wherein at least 90% of the discrete plant-sourced lipid and inulin crumble pieces have a particle size of from 1.5 mm to 26 mm.

55. The plant-sourced lipid and inulin crumble pieces of claim 54, wherein the pieces comprise lipid mixed with inulin gel at a lipid/inulin gel weight ratio of from about 20 to about 60 wt %.

56. A process of preparing an animal meat mimetic comprising:
mixing a plant protein composition with water to form a hydrated plant protein composition; and
mixing the hydrated plant protein composition with the discrete plant-sourced lipid and inulin crumble pieces of claim 54 under chilling conditions at a temperature low enough to maintain a particulate nature of the discrete plant-sourced lipid and inulin crumble pieces to prepare an animal meat mimetic.

57. The process of claim 56, wherein the hydrated plant protein composition is pre-chilled to a temperature of from about 0° C. to about 10° C. before mixing with the discrete plant-sourced lipid and inulin crumble pieces.

58. The process of claim 56, wherein the combined plant protein/particulate compositions mix is maintained at a temperature less than 10° C.
